(19) United States
(12) Patent Application Publication
(10) Pub. No.: US 2007/0000160 A1
(43) Pub. Date: Jan. 4, 2007

(54) UNIVERSAL SILKSCREEN SECUREMENT DEVICE

(76) Inventor: JAMES D. LARSON, Snohomish, WA (US)

Correspondence Address: JENSEN + PUNTIGAM, P.S., SUITE 1020, 2033 6TH AVE, SEATTLE, WA, 98121, US

(21) Appl. No.: 11/470,891

(22) Filed: Sep. 7, 2006

Related U.S. Application Data
(63) Continuation-in-part of application No. 11/136,811, filed on May 24, 2005.
Application No. 11/136,811 is a continuation-in-part of application No. 10/879,896, filed on Jun. 29, 2004, now abandoned.

(51) Int. Cl. B41J 11/38

(52) U.S. Cl. 40/341

(57) ABSTRACT

A universal silkscreen securement device for reliable attaching and tensioning a pre-cut silkscreen having peripheral securement devices to a variety of frames allowing the full use of the screen surface.

### TECHNICAL FIELD

This is a continuation-in-part of patent application Ser. No. 11,136,811, filed Jan. 19, 2006, which is a continuation-in-part of patent applications Ser. No. 10,879,896, filed Jun. 29, 2004. This invention related to a device for securing a pre-cut silkscreen panel having peripheral connectors to a stretching frame, and more particularly, to a device which allows securement to a variety of frames, enabling a versatility of use, and since it allows the reuse of the screen, as well as the use of a smaller screen size to the screen the same image, results in considerable savings in the silkscreen operation.

### BACKGROUND OF THE INVENTION

The silkscreen industry, which requires that the screens used for the screening process be under a pre-determined tension to assure that the transfer is crisp and has sharp edges, have secured the screen to frames which allowed the screen to be stretched to the desired tension. Over the years, the frames have evolved from rectangular frame elements which were moved away from each other to stretch the fabric elements which were moved away from each other to stretch the fabric to roller or cylindrical frame elements wherein each side are tubes which are turned about their axes to stretch the screen attached thereto. While these methods were in fact effective, they have several draw backs, including the fact that they required a fair amount of silkscreen to be wasted since the screen was attached directly to the frame and the portion adjacent the frame was not usable, and further, that the tension could not be maintained at the corners of the rectangular frame element since the screen could not be attached completely to the corner of the frame. As the cost of the silkscreen has increased, and as the demand for more precision printing has likewise increased, it has been recognized that there needs to be a reliable, inexpensive way to meet these needs. It has been recognized that if a silkscreen is pre-cut and bonded to a border which interlocks with the silkscreen frame, a substantial amount of waste is reduced.

It was further recognized that if there is provided a bridging mechanism between the bordered silkscreen and the frame, the additional benefits would be again a reduced screen size, reduced waste, more even tension throughout the screen, since the bridging member absorbs the corner problem and further if the bridging member is flexible, then the movement of the screen during the screening process is again absorbed by the bridging member and allows more of the screen to be utilized since the screen remains substantially uniplanar.

### BACKGROUND ART

Prior art known to the inventor includes:

U.S. Pat. No. 3,42,243, granted to Hamu on Dec. 9, 1969, which discloses a rectangular frame including means to place tension about a fabric captured within an inner frame.

U.S. Pat. No. 3,507,062, granted to Moyer on Apr. 21, 1970, which likewise teaches an apparatus including means to stretch fabric.

U.S. Pat. No. 4,899,797, granted to Green on Feb. 13, 1990, discloses a screen retainer strip assembly.

U.S. Pat. No. 5,379,691, granted to Hamu et al on Jan. 10, 1996 discloses a system of screen anchors that are bonded to the screen and then captured within the frame.

U.S. Pat. No. 6,318,255 B1, granted to Larson on Nov. 20, 2001, discloses a method of securing coated fabric to an edging element.

U.S. Pat. No. 6,945,305 B1, granted to Laimauro on Sep. 20, 2005, discloses a screen frame reinforcement element.

U.S. Publication No. 2006/0010730 A1, authored by Larson, discloses a flexible securement element to more economically silkscreen.

### DISCLOSURE OF THE INVENTION

With the above-noted prior art in mind, it is a purpose of the present invention to provide a linking member between a frame element and a pre-cut silkscreen element containing edge elements to enable versatile and efficient screen prioritizing.

Yet another feature of the present invention is to provide a universal linking mechanism for silkscreen printing that can be used with substantially all of the commercially available stretching frames.

A further feature of the present invention is to provide a linking member for use in silkscreen stretching, which allows the screen to be substantially all of the commercially available stretching frames.

A further feature of the present invention is to provide a linking member for use in silkscreen stretching, which allows the screen to be substantially uniplanar during the screening process.

### BRIEF DESCRIPTION OF THE DRAWINGS

FIG. 1 discloses a preferred embodiment of the securement device for use with a roller frame.

FIG. 2 is a vertical sectional view through the securement device of FIG. 1.

FIG. 3 is an exploded view of a securement device of FIG. 1.

FIG. 4 is a disclosure of a second version of the securement device.

FIG. 5 is a vertical sectional view of the device of FIG. 4.

FIG. 6 is a third embodiment of a securement device.

FIG. 7 is a vertical section of the device of FIG. 6.

### BEST MODE FOR CARRYING OUT THE INVENTION

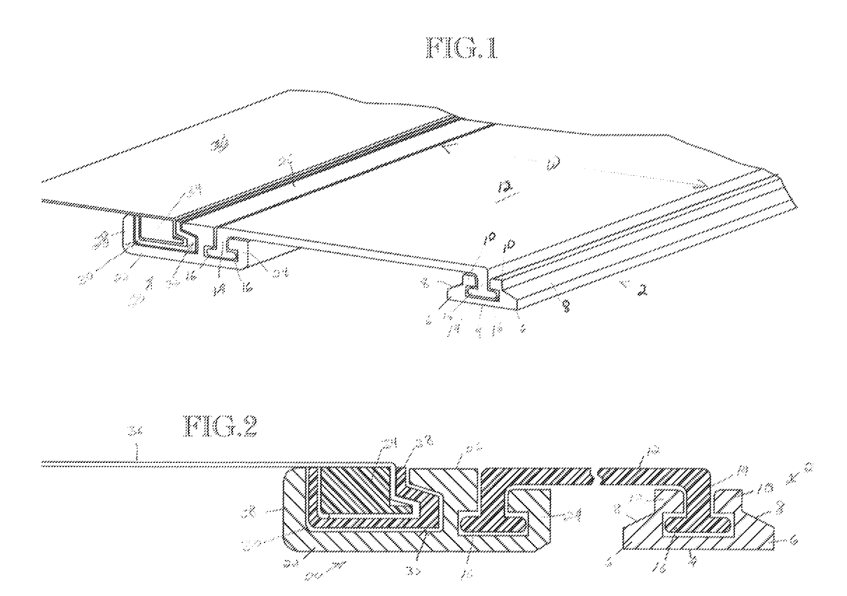

As seen in FIG. 1, a securement device in one embodiment includes a rigid fastening element 2 with a cross section of a pyramidal symmetric shape about a center line having a substantially flat bottom 4, a pair of outwardly extending wings 6, a pair of tapering upper portions 8 terminating at the top with an inwardly facing lip 10 to secure the outer edge of a bridging member 12 which has a leg 14 terminating in opposing feet 16 which snap fit into a cavity created by the lip or ledge 10. It is to be understood that the fastening element 2 is designed to be slipped into a roller frame and is symmetrically designed so that it my be used in any one of the four roller frame elements that comprise the roller frame itself.

The intermediate element 12 is comprised of a flexible chemical resistant plastic such as a polyethylene which has shown substantial durability in the field and the thickness will vary depending upon the amount of flexibility desired. The length of the intermediate element 12 will depend of course upon the length of the side element of the roller frame and the width W will control the amount of tension put upon the silkscreen, since as explained hereinafter, it will limit the amount of rotation in a retensionable frame. The opposite edge of the intermediate element 12 has a symmetrically downwardly depending leg 14 and opposite feet 16 which fit into a recess in the first edge of second fastening member 20, which has a generally flat bottom surface 22, a first edge 24 to receive the leg/foot 14, 16 and a generally flat, narrow upper surface 26. The second edge of fastening element 20 includes an upwardly extending leg 28 forming one side of a configured cavity 30 which includes a recess 32 to receive and capture the connector 34 to which the silkscreen 36 is attached.

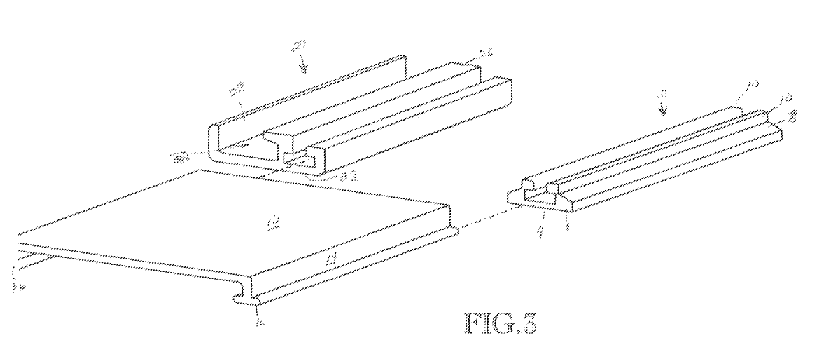

The interrelationships of the various elements of FIG. 1 may perhaps more easily be seen in FIG. 2, wherein it can also be seen that there is a liner 38 within the cavity 32 surrounding the connector 34.

An exploded view further showing the interrelationship of the various elements is seen in FIG. 3.

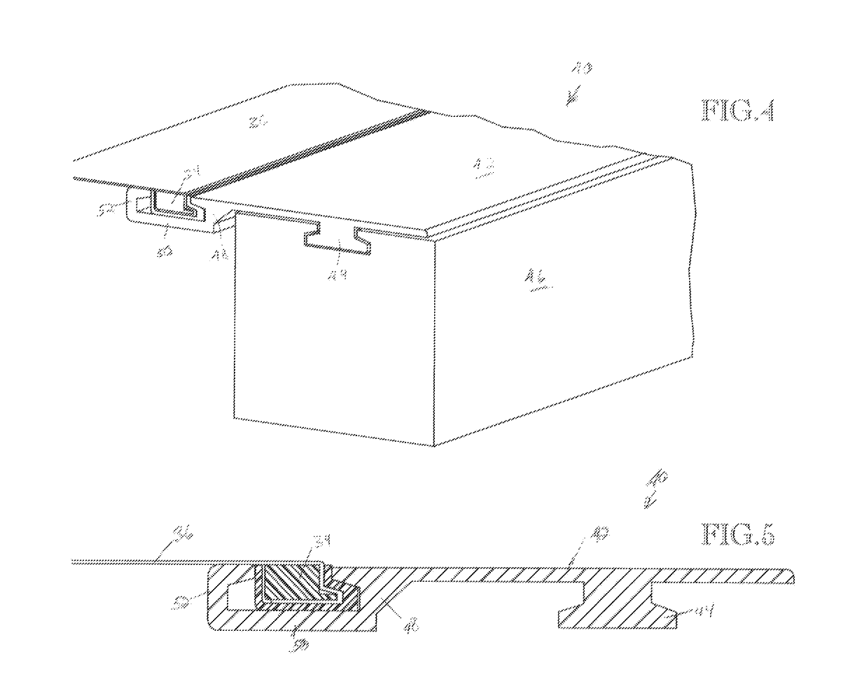

As seen in FIGS. 4-6, the second embodiment of the universal securement device includes a flat, rigid portion 42 having a downwardly depending foot element 44 which snaps into the top surface of a rectangular frame member 46 and extends outwardly beyond the edge of the frame member 46 to terminate in an elongated channel formed by the edge of member 42, a downwardly depending configured wall 48, a bottom element 50 and an upwardly extending lip 52 to capture the connector 34 of the silkscreen 36.

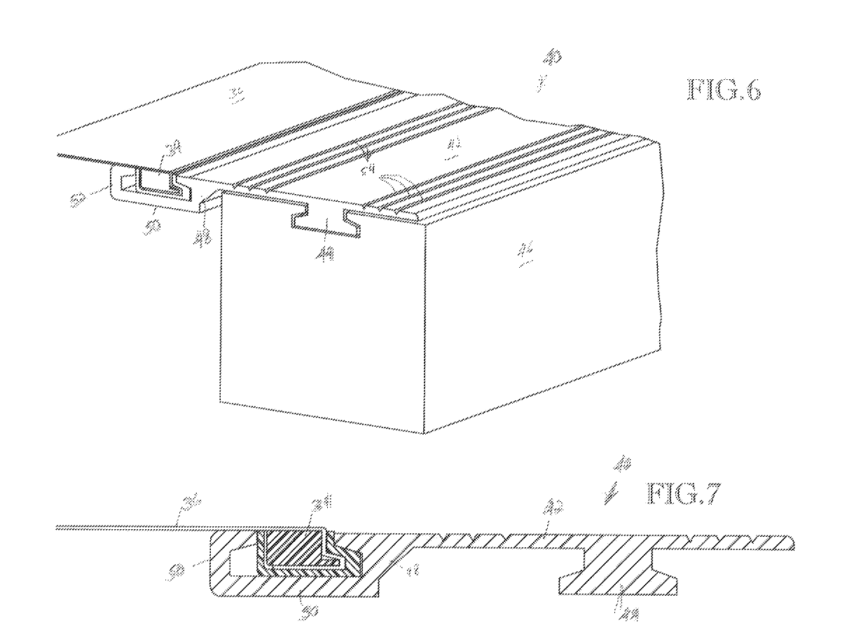

It is to be noted that the embodiment shown in FIGS. 6 and 7 has a series of elongated upper surface grooves 54 to generate friction when the clamping means is applied to secure the securement device to the stretching frame.

Thus, as can be seen, the current invention allows the efficient and universal use of a connector to secure a silkscreen to a stretching frame.

1. A securement device for use in the silkscreen industry for securing a precision cut pre-shaped silkscreen including peripheral connectors to a stretching frame, comprising:
An elongated relatively flat connector element to secure one side of the silkscreen including a groove along one edge thereof to receive a connector secured to the silkscreen and a configured ridge along the opposite side and edge for locking the element to the stretching frame, whereby the silkscreen can be smaller, saving waste, and may be reused.

2. An apparatus as in claim 1, wherein the apparatus is unitary.

3. An apparatus as in claim 1, wherein the apparatus is flexible.

4. An apparatus as in claim 1, wherein the apparatus comprises interlocking parts.
